(19) United States
(12) Patent Application Publication
(10) Pub. No.: US 2008/0092060 A1
(43) Pub. Date: Apr. 17, 2008

(54) SYSTEM AND METHOD FOR CAPTURING WEBSITE USER FEEDBACK

(76) Inventors: Jordan Berg, Mill Valley, CA (US); Neeld Dunlap Tanksley, San Jose, CA (US)

Correspondence Address: DLA PIPER US LLP, P. O. BOX 9271, RESTON, VA, 20195, US

(21) Appl. No.: 11/550,177

(22) Filed: Oct. 17, 2006

(51) Int. Cl. G06F 3/00

(52) U.S. Cl. 715/748

(57) ABSTRACT

Systems and methods for capturing user feedback in real-time over a communication network are described, where user feedback functionality is embedded directly in a web page. In one embodiment, the web page of a service provider includes JavaScript code which provides a listener server with control of the content of the web page. The customer feedback functionality may be in the form of queryboxes that are displayed to the user upon the occurrence of events, such a user positioning the cursor in a particular form field. Upon occurrence of the event, a querybox is displayed with a request for user input related to the form field. User selection and submission of a response via the querybox is communicated to the listener server where the information is organized such that the web page provider can view the user feedback.

### BACKGROUND

1. Field of the Invention

The invention relates generally to the field of data capture, and more particularly, to dynamic capture of website user feedback.

2. Description of Related Technology

Data capture techniques have long been used by consumer product and service providers (collectively “providers”) in order to better understand the demographics, needs, and desires of their customers, as well as the reasons why customers fail to complete purchases or request services. A number of techniques have been adopted over the years to capture relevant information from a sampling of a provider's customers in order to develop desired metrics so as to better understand the interests of those customers.

For example, providers often offer a survey to particular customers with questions tailored toward determining various customer interests, possibly offering an incentive to those customers who complete the survey to ensure that enough of a sample set of customers complete the survey so that accurate metrics can be collected. Another common technique for obtaining customer feedback is to contact a subset of a provider's customer base and conduct the survey in real-time over the telephone. The advantage of this type of communication lies in the ability to tailor the survey depending on the customers' responses.

These types of techniques do not apply themselves well to an Internet context where users are not receptive to the intrusive and time consuming methods discussed above. The Internet is an ever-evolving set of web pages and content, and information can change almost immediately. Thus, providers need the ability to immediately ascertain feedback from their customers concerning the providers' web pages and content so that a more efficient, useful, and informative website can be maintained and offered to interested users. Important benefits to providers in having this information as soon as possible are that it allows them to better gauge the reason for user drop-off on their websites, and to determine how they can improve customer conversion and retention.

There have been few techniques adopted for capturing user feedback in the Internet context and none have been particularly effective. For example, Optimost utilizes a technique referred to as A/B testing. Optimost allows a web page designer to generate a template of multiple versions of a particular web page and subsequently integrate JavaScript code into the HTML code for the web page being optimized, such that the JavaScript code determines which of the multiple versions of the web page to display to the visitor. However, this technique does not allow for the capture of user feedback in real-time, but instead uses metrics to track the user's interests and select what might be of most interest to the user based on those metrics. Offermatica employs a similar technique.

Another approach is offered by Opinionlab. Opinionlab offers a technique for capturing user feedback which relies principally on user-initiated actions rather than prompting by the web page. For example, a user viewing a web page enabled with Opinionlab's technology can select a floating plus sign (+) icon on the web page and manually “score” the web page in the matter of seconds. The Opinionlab technology also enables a user to open a comment card and express their own opinions and answer particular pre-generated questions. As noted, these actions are all user-initiated and accordingly, rarely effective in gathering the desired information from a large enough sample set to provide valuable feedback for the product or service provider. Moreover, because this technique is user-initiated, it does not provide a method of gauging specific customer feedback for specific portions of a website, where such feedback is desired to better understand why customers are dropping-off the website and how better to retain future customers.

Thus, a system and method for obtaining customer feedback that is tailored to specific web page content and effective in reaching a significant sample of customers is needed in the art.

### SUMMARY OF CERTAIN INVENTIVE EMBODIMENTS

The embodiments described below are methods and systems for capturing website user feedback, which substantially eliminates or reduces disadvantages and problems associated with previous systems and methods.

According to one embodiment, there is provided a method of capturing user input upon user viewing of a web page, including providing a web page with at least one trigger for displaying a request for user input, providing a prompt requesting user input specific to an element of the web page in response to an automatic trigger event, receiving user input in response to the request, and storing the received user input.

According to another embodiment, there is provided a system for capturing user input upon viewing a web page, including a listener server coupled to a communications network and configured to store content for modifying at least one web page with functionality that enables automatic capture of user input upon viewing of the web page, wherein the content comprises at least one trigger event and a corresponding prompt requesting user input customized to the trigger event.

In accordance with another embodiment, the system for capturing user input upon web page viewing includes a web page server coupled to a communications network and configured to respond to a client computer request to load a web page, modify the web page to include functionality that enables automatic capture of user input upon viewing of the web page, and send the modified web page to the requesting user, wherein the modified web page comprises at least one trigger event and at least one corresponding prompt requesting user input customized to the trigger event.

The method of capturing user input upon vie wing of a web page, in accordance with another embodiment, includes receiving a user request to load a web page including user input capture functionality, requesting user input capture functionality content from a listener server, receiving content to enable user input capture functionality on the web page, wherein the received content comprises at least one trigger event and corresponding prompt requesting user input specific to an element of the web page, modifying web page content to include at least a portion of the received content, and sending the modified web page to the user.

According to another embodiment, the method of providing content for modifying a web page to include customized user input capture functionality includes receiving a request from a web page server for user input capture functionality content for a web page, identifying and sending content to enable user input capture functionality for the web page to the web page server, wherein the content comprises at least one trigger event and at least one prompt requesting user input customized to the trigger event, and receiving user input in response to the prompt.

The method of capturing user input upon user viewing of a web page according to another embodiment includes requesting a web page comprising automatic user input capture functionality loading and displaying a web page enabled with automatic user input capture functionality content, wherein the content comprises at least one automatic trigger event and a corresponding prompt requesting user input specific to an element of the web page, detecting the at least one trigger event and displaying the corresponding prompt requesting user input specific to an element of the displayed web page, receiving user input in response to the displayed prompt, and sending the user input to a listener server.

Other embodiments and features will become apparent from the following description with reference to the accompanying drawings.

### BRIEF DESCRIPTION OF THE DRAWINGS

FIG. 1 is a screenshot of an exemplary querybox for obtaining user feedback.

FIG. 2 is a block diagram of one embodiment of a system for capturing web site user feedback.

FIG. 3 is a flow diagram illustrating one embodiment of processes and functions performed at a client computer in a method of capturing feedback from a web page user.

FIG. 4 is a flow diagram illustrating one embodiment of processes and functions performed at a web page server in a method of capturing feedback from a web page user.

FIG. 5 is a flow diagram illustrating one embodiment of processes and functions performed at a listener server in a method of capturing feedback from a web page user.

FIG. 6 is a screenshot of an exemplary administrative tool for generation of a listener for a web page.

FIG. 7 is a flow diagram illustrating one embodiment of a method of generating a listener object for a web page.

FIG. 8 is a screenshot of an exemplary administrative tool for generating a listener object for a web page.

### DETAILED DESCRIPTION OF CERTAIN INVENTIVE EMBODIMENTS

The embodiments will now be described with reference to the accompanying Figures, wherein like numerals refer to like elements. The terminology used in the description is not intended to be interpreted in any limited or restrictive manner simply because it is being utilized in conjunction with a detailed description of certain specific embodiments. Furthermore, the embodiments may include several novel features, no single one of which is solely responsible for its desirable attributes or which is essential to practicing the described embodiments.

In an embodiment, a system and method of capturing user feedback in real-time over a communication network such as the Internet is provided. This may include embedding automatic customer feedback functionality directly in web pages such that feedback can be tailored to content within the web page. In one embodiment, the web page of a service provider includes JavaScript code which provides a listener server with control of the content of the web page. The listener server decides whether the web page should include customer feedback functionality and provides such functionality to the provider's web server.

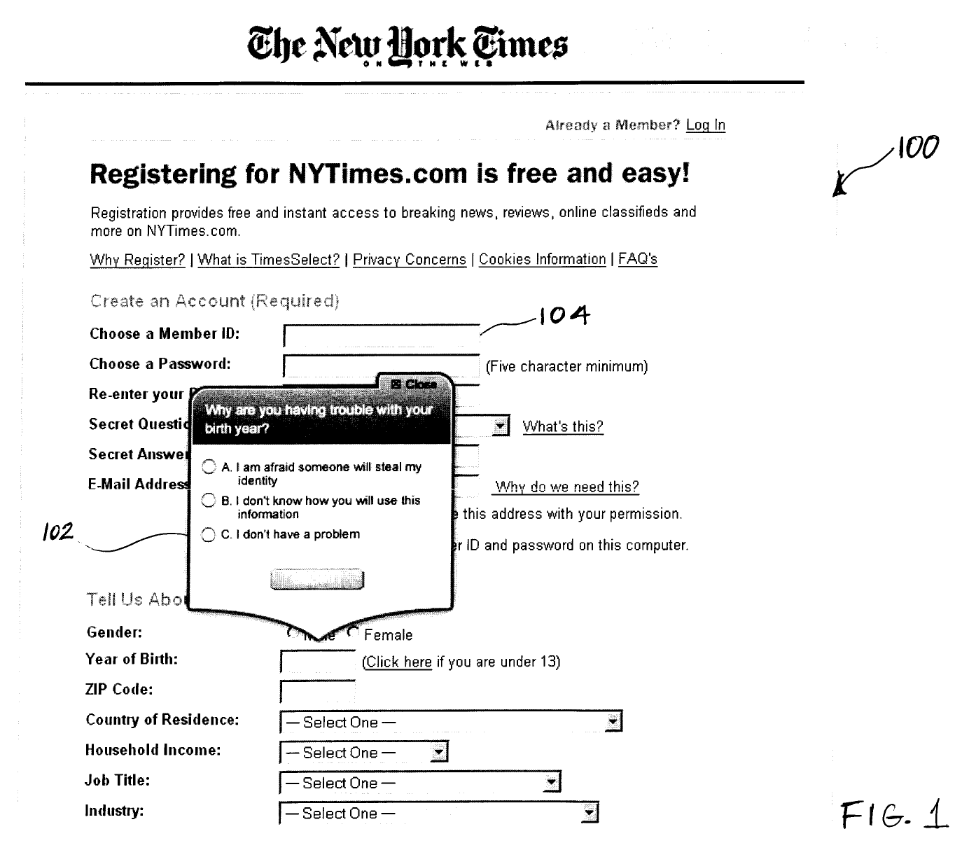

The customer feedback functionality may be in the form of user prompts or queryboxes that are displayed to the user upon the occurrence of events defined at the listener server. FIG. 1 is a screenshot of a web page 100 and an exemplary querybox 102 with user input options. A web page may include form fields or text input boxes 104 for user input, as illustrated in FIG. 1. When a user positions the cursor in a particular form field, such as a field labeled “Date of Birth”, and the cursor remains idle for a specified time period, a querybox is displayed with a request for user input related to the form field. For example, the querybox 102 may contain text asking the user “Why are you having trouble with your date of birth?”, and the user is given options for responding, such as selection of one of the following: “I don't want you to know how old I am”, “I am concerned about identity theft”, “I am not having a problem”.

User selection and submission of a response via the querybox is communicated to the listener server where the information is organized such that the service provider can view the customer feedback. The tailored questions allow the provider to identify specific aspects of their web page which customers find troublesome, or cause for abandoning service subscription or product purchase. In addition, the automatic functionality provides for the capture of user feedback without user input or user selection of the feedback functionality, thereby increasing the probability of capturing user feedback.

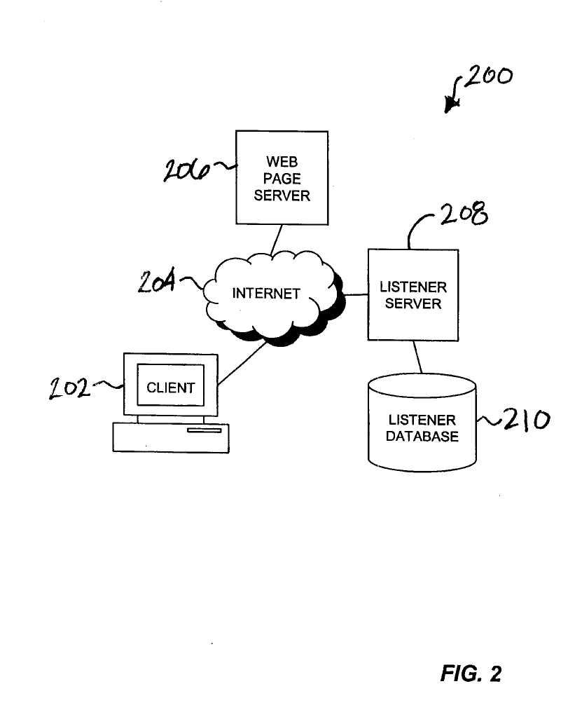

FIG. 2 is a block diagram of one embodiment of a system 200 for capturing web site user feedback. The system 200 comprises a client computer 202 coupled to a communications network 204, such as the Internet. The client computer 202 includes a web browser, such as Microsoft Internet Explorer, Netscape, or Mozilla, for displaying web pages. The client computer 202 also comprises a display and one or more user input devices, such as a keyboard, mouse, trackball, and/or touchscreen. The system 200 further comprises a web page server (web server) 206 coupled to the network 204 and configured to store a website comprising one or more web pages. The user feedback capture system 200 further comprises a listener server 208 coupled to the network 204 and configured to facilitate user feedback functionality for one or more web pages. In one embodiment, the listener server 208 is also configured to generate a listener and one or more listener objects for one or more web pages. A listener database 210 is also in communication with the listener server 208 and configured to store information, such as user feedback for a web page enabled with user feedback functionality. In one embodiment, the listener database 210 is configured to store user feedback for review by a provider, and to store information for generation and facilitation of listener functionality.

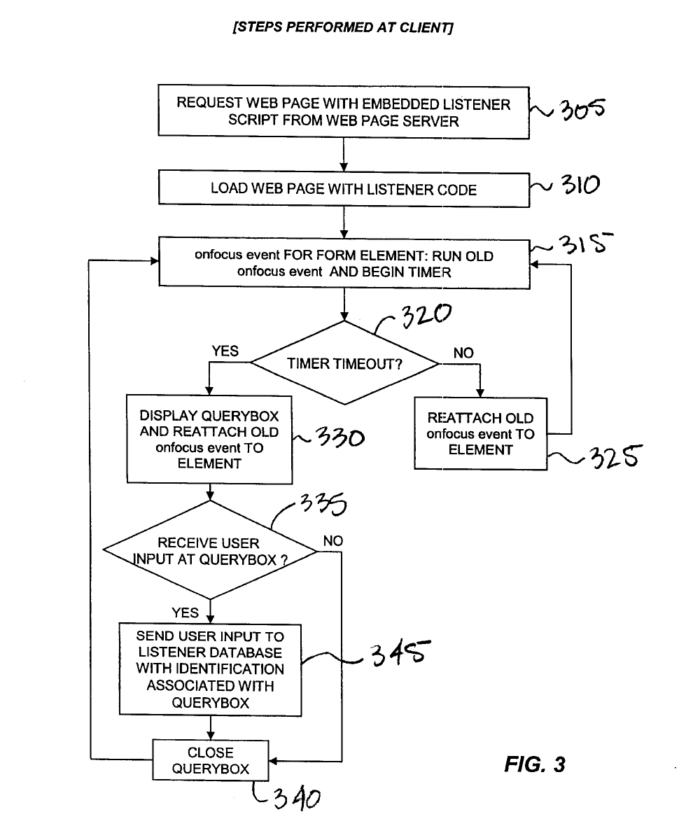

FIGS. 3-5 are flow diagrams illustrating embodiments of a method of capturing feedback from a web page user. The method will be described in reference to the current technology employed for the world wide web (WWW). However, the embodiments are not limited by such descriptions or the current technology and may be employed in other systems and networks with different organization and coding. As known in the technology, a web page can be either a single page, or a frameset made up of separate frames. Each frame contains a hypertext markup language (HTML) page. A collection of web pages stored in a single folder or within related subfolders of a web server is referred to as a website. A web browser operates to display the web page according to the HTML.

A web page may include content that is not seen by the browser, such as scripts (e.g., JavaScript). Script code may be executed as the document loads at the client computer or at a later time. In one embodiment, listener functionality is provided via JavaScript code embedded within the HTML code for a web page. JavaScript is used to write functions that are embedded in or included from HTML pages. Further, JavaScript interacts with a Document Object Model (DOM) of the web page to perform tasks that may not be possible to perform using HTML alone. For example, such a function may comprise opening or popping up a new window with programmatic control over the size, position, and ‘look’ of the new window (e.g., whether or not the menus, toolbars, etc. are visible). Another use of JavaScript in web pages is to make calls to web and web-service servers after the page has loaded, depending upon user actions. These calls can obtain new information, wherein the JavaScript can merge with the existing page's DOM so that it is displayed.

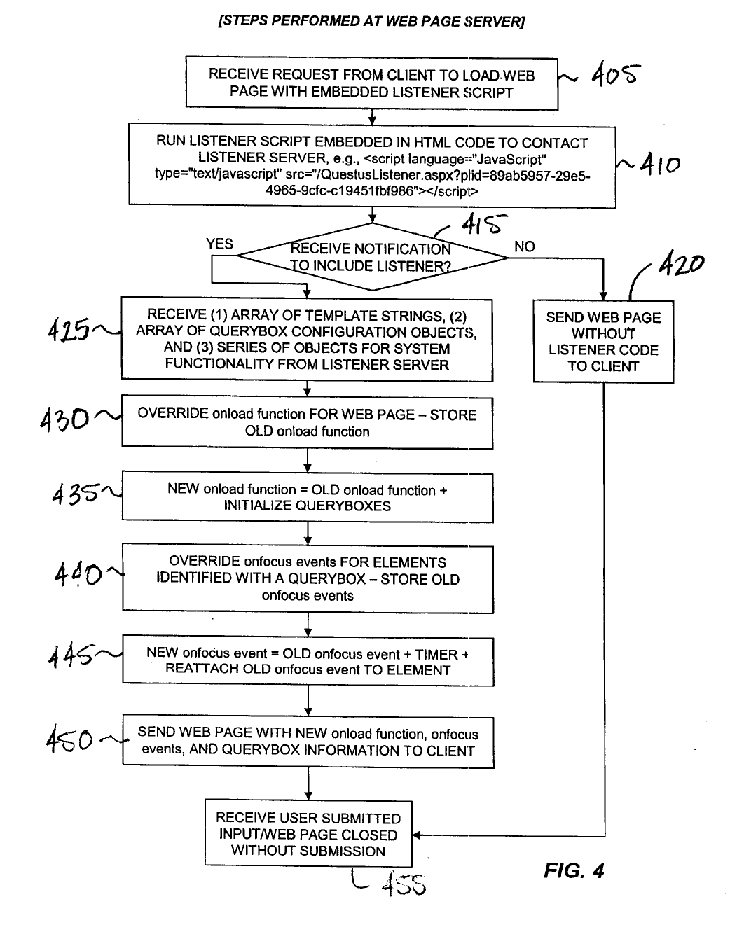

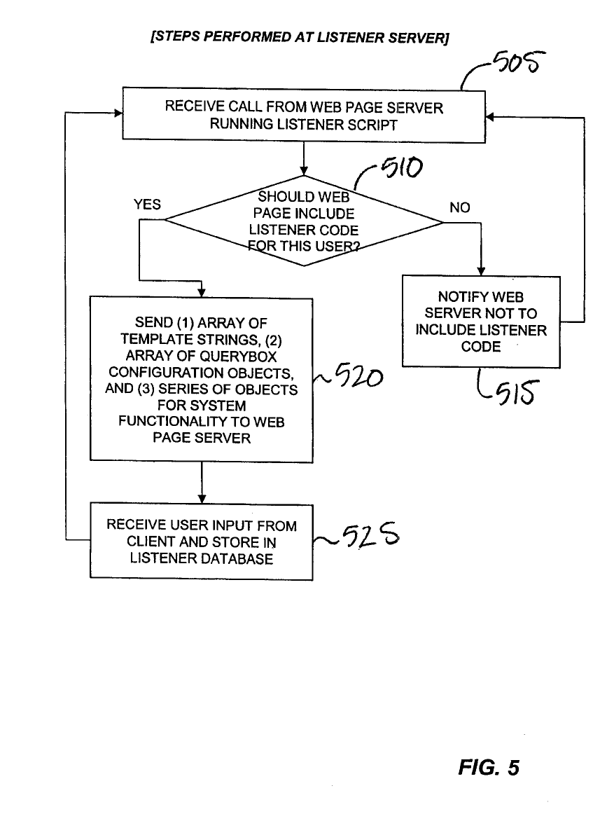

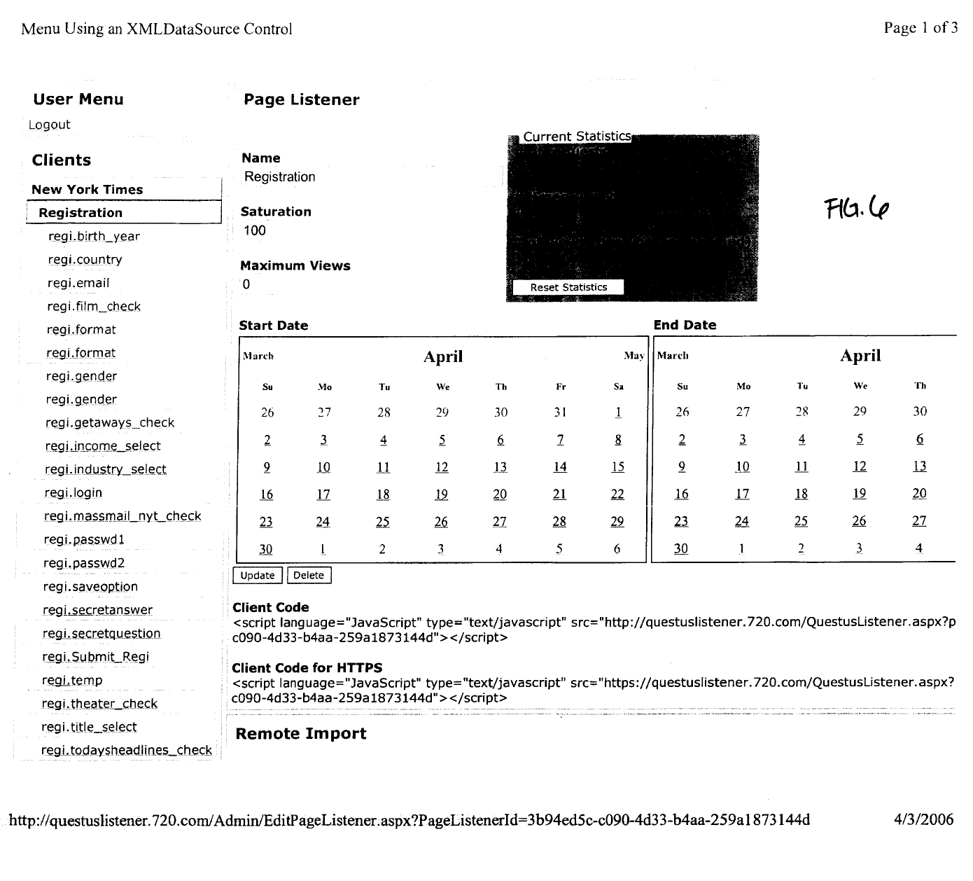

As noted above, FIGS. 3-5 are flow diagrams illustrating embodiments of a method of capturing feedback from a web page user, wherein FIG. 3 illustrates the processes and functions performed at the client computer 202, FIG. 4 illustrates the processes and functions performed at the web page server 206, and FIG. 5 illustrates the processes and functions performed at the listener server 208.

As illustrated in operation 305 of FIG. 3, the client computer 202 requests a web page from the web page server 206, wherein a listener script is embedded in the HTML code for the web page. In one embodiment, the listener script may be developed using JavaScript code. As illustrated in FIG. 4, the web page server 206 receives the request from the client computer 202 in operation 405. In operation 410, the web page server 206 runs the listener script code in order to contact the listener server. For example, the listener script may appear in the HTML code as follows:

<script language=“JavaScript” type=“text/javascript”
src=“/QuestusListener.aspx?plid=89ab5957-29e5-4965-9cfc-
c19451fbf986”></script>

As illustrated in FIG. 5, the listener server 208 receives a call from the web page server 206 running the listener script in operation 505. In operation 510, the listener server 208 determines whether the web page should include listener code for the requesting user. For example, the web page provider may indicate a percentage of their users that are to be prompted for feedback. This percentage is stored at the listener database 210. In an embodiment, the listener server 208 may use, for example, a counter to identify the user requests to receive listener functionality according to the designated. In operation 510, the listener server 208 determines whether the requesting user should receive the web page that includes the listener code. If the listener server 208 determines that the user should receive the web page that includes the listener code, then the listener server 208 notifies the web page server 206 in operation 515 that the web page should not include listener code. After operation 515, the listener server 208 returns to operation 505. In one embodiment, the listener server 208 is configured to provide listener functionality to all users requesting the web page such that the method proceeds from operation 505 directly to operation 520.

If the listener server 208 determines in operation 510 that the requesting user should receive the web page with the listener code, the listener server 208 sends (1) an array of template strings, (2) an array of querybox configuration objects, and (3) a series of objects for system functionality to the web page server 206 in operation 520. In one embodiment, the template strings are not sent to the web page server 206 every time the web page is requested so as to reduce bandwidth usage. For example, the listener server 208 may send the template strings periodically, such as once a day, and store the template strings at the web page server 206. Alternately, the listener server 208 may send the template strings only when updated. In one embodiment, the querybox configuration objects comprise the name of the web page element each querybox is to be attached to on the web page (e.g., particular form field), and a string that is the dynamically generated form for each querybox, wherein the string contains the encoded and compressed version of the form that will be presented to the user. The querybox configuration objects further comprise x/y offset information for each querybox. The x/y offset is configured to include information for positioning the querybox on the page. In reference to the querybox illustrated in FIG. 1, a template string provides information for the physical appearance of the querybox and may or may not include text. The dynamically generated form for a querybox comprises the customized text for the particular element, such as the question to the user (“Why are you having trouble with your birth year,?”) and the options for user input (“I am afraid someone will steal my identity”, etc.). In one embodiment, the listener server 208 sends a series of objects containing configuration information about a specific client's setup that includes, but not limited to, a client identifier string, URL where data will be posted, and a validation key to ensure that data received is from a known request. The information provided in operation 520 further includes a unique identifier associated with each querybox. The unique identifier identifies, for example, the web page provider, the web page element the querybox is associated with, and the type of information the querybox is requesting. Further, the unique identifier is a globally unique identifier (GUID) that allows a query box to be associated with a specific client, page, and page request. The GUID can be used to look up all information related to a querybox from the time of it's creation up to it's being responded to by the user to whom it was presented.

Referring back to FIG. 4, the web page server 206 waits to receive notification from the listener server 208 as to whether to include listener code in the web page requested by the client computer 202. If the web page server 206 does not receive notification to include the listener code, then the web page server 206 sends the web page without listener code to the client computer 202 in operation 420. If the web page server 206 receives notification in operation 415 to include listener code in the requested web page, then the web page server 206 receives the (1) array of template strings, (2) array of querybox configuration objects, and (3) series of objects for system functionality from the listener server 208 in operation 425.

Using the information received in operation 425, the web page server 206 modifies the requested web page to include the listener code. In one embodiment, the web page is modified according to an event model. An event is a notification that occurs in response to an action or as a result of the user clicking the mouse or pressing a key while viewing the web page. An event handler is code, such as a function or routine written in scripting language, that receives control when the corresponding event occurs. An event begins with the action or condition that initiates the event. When the event is activated, the associated event handler is called, and the event handler carries out its action. In one embodiment, listener functionality employs the use of onfocus events and onload events. An onfocus event activates when an element gains focus. For example, when the cursor is positioned on an element such as a textbox or form field, an onfocus event activates. An onload event activates when an element finishes loading. For example, when a script is initiated after a web page loads onto a client computer, an onload event is activated.

In reference still to FIG. 4, the web page server 206 overrides the onload function for the requested web page and stores the old onload function. A new onload function is generated in operation 435 using the information received in operation 425, wherein the new onload function comprises the old onload function and an initialization of one or more queryboxes. Similarly, in operation 440, the web page server 206 overrides the onfocus event for each web page element identified with a querybox and stores the old onfocus events. A new onfocus event for each element identified with a querybox is generated in operation 445, wherein the new onfocus event comprises the old onfocus event, initialization of a timer, and the reattachment of the old onfocus event to the element. For example, the onfocus event may comprise movement of the cursor into the form field labeled “Year of Birth”. As will be appreciated by persons skilled in the art, the trigger for the querybox may be based on an event other than an onfocus event and may or may not include a timer with an overriding function. For example, the querybox trigger event may be an error, such as user input of invalid characters or information in a form field. Other contemplated event triggers include mouse events (e.g., onclick, onmouseover), keyboard events, selection events, time events, and onload events.

Following generation of the new onfocus events in operation 445, the web page server 206 sends the user requested web page with the new onload function, new onfocus events, and querybox information to the client computer 202 in operation 450. The web page server 206 then receives user submitted input, e.g., via form fields, or the user closes the web page without submission of information in operation 455.

Referring back to FIG. 3, the client computer 202 loads the web page with listener code received from the web page server 206 in operation 310. According to the new onload event, the client computer initializes the queryboxes for the loaded web page. The web page now includes one or more automatic trigger events for prompting a user for input. In the present embodiment, one of the automatic trigger events is a combination of an onfocus event and a timer. Upon the occurrence of the onfocus event for a form element as designated in the loaded web page, the client computer 202 runs the old onfocus event and begins a timer in operation 315. For example, when the user of the client computer 202 moves the cursor to the form field labeled “Year of Birth”, a timer is initiated for a preset time period designated by the listener code. If the timer is interrupted by a designated event, such as keyboard input or movement of the mouse to another form field, then the client computer 202 reattaches the old onfocus event to the element (if relevant) in operation 325 and returns to operation 315 to await another onfocus event.

In operation 320, if the timer initiated by the onfocus event times out, then the client computer 202 displays the querybox attached to the web page element to the user and reattaches the old onfocus event to the element in operation 330. In one embodiment, displaying the querybox comprises display of a hidden div element over the active element, wherein the contents of the div element are set by merging the specified template with the dynamically generated form for the element. For example, the querybox 102 illustrated in FIG. 1 may consist of a div element displayed over the form fields of the web page 100, wherein the contents of the querybox 102 are set by merging the querybox template (e.g., the physical appearance such as shape, size color, graphical elements) with the dynamically generated form (e.g., the question associated with the form field and options for user input).

Referring again to FIG. 3, if the user does not provide input to the querybox in operation 335, the client computer 202 closes the querybox in operation 340 and returns to operation 315 to await another onfocus event. However, if the client computer 202 receives user input at the querybox in operation 335, the client computer 202 sends the user input to the listener database 210 with the unique identification associated with the querybox in operation 345 and closes the querybox in operation 340. The user input is sent to the Listener Web Server, which can be identified by a name (ex: listenerserver.com) or by an IP address. The data sent includes the GUID that identifies the querybox and the name/value pairs that indicate the user response. The name part of the name/value pairs is a GUID that identifies a specific option of a specific question of a specific querybox.

In FIG. 5, the listener server 208 receives the user input from the client computer 202 and stores the user input in the listener database 210 in operation 525. In one embodiment, communication between the client computer 202 and the listener server 208 occurs via an invisible iframe on the web page, wherein the listener code included in the web page loaded at the client computer 202 in operation 310 (FIG. 3) includes appropriate code for the iframe. The dynamically generated form of the querybox is posted to the iframe such that the user input is accordingly posted to the listener server without opening a new window or leaving the loaded web page.

The listener server 208 is configured to organize and track user feedback statistics for each web page such that a provider can access such information in real time. The user feedback information is stored in a series of linked database tables that allows every operation of the life cycle of a querybox to be recorded for both queryboxes that are served to end users as well as those queryboxes that are not served to end users due to triggers such as timeouts that are not activated. This allows the entire process to be reconstructed and analyzed at a later date.

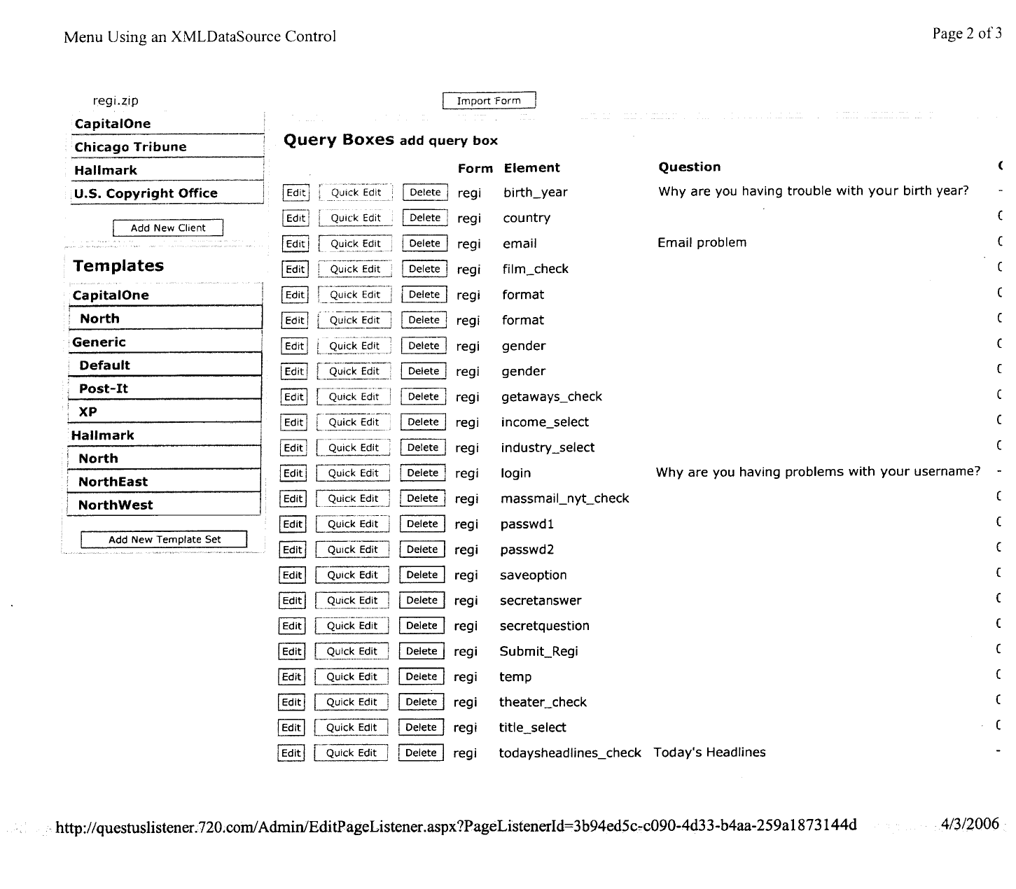

FIG. 6 is an exemplary screenshot of an administrative tool for generation of a web page listener. In one embodiment, the administrative tool is web based and is stored at the listener server 208, such that the tool can be accessed over the network 204. The administrative tool may provide access to listeners for multiple web pages and for multiple providers. When a web page comprises a form, the administrative tool can be used to generate listener objects for fields in the form, wherein the user selects the field and the form of the web page for attachment of a listener object. For example, a user may generate a listener object for a field or element labeled “birth_year” in the registration form (“regi”) for a provider web page. In one embodiment, the administrative tool displays the listener objects currently associated with a web page form, as illustrated in FIG. 6, with the option to edit or delete the object. The administrative tool may also display the querybox text for each listener object, and the listener object information for a web page form may be displayed, for example, in tabular form. The web page listener objects may be collectively referred to as a “web page listener”, where each web page listener has an address associated with it which is part of the script code embedded in the corresponding web page HTML code.

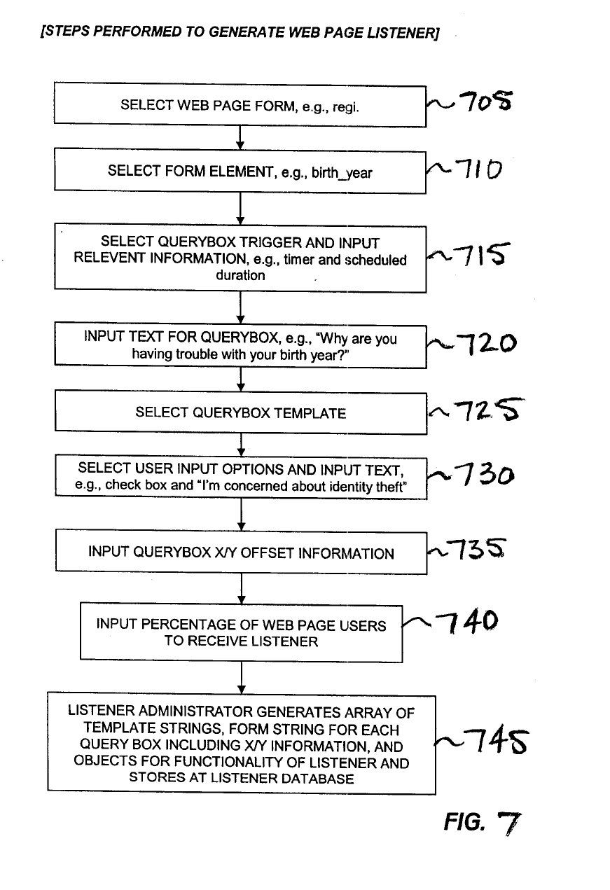

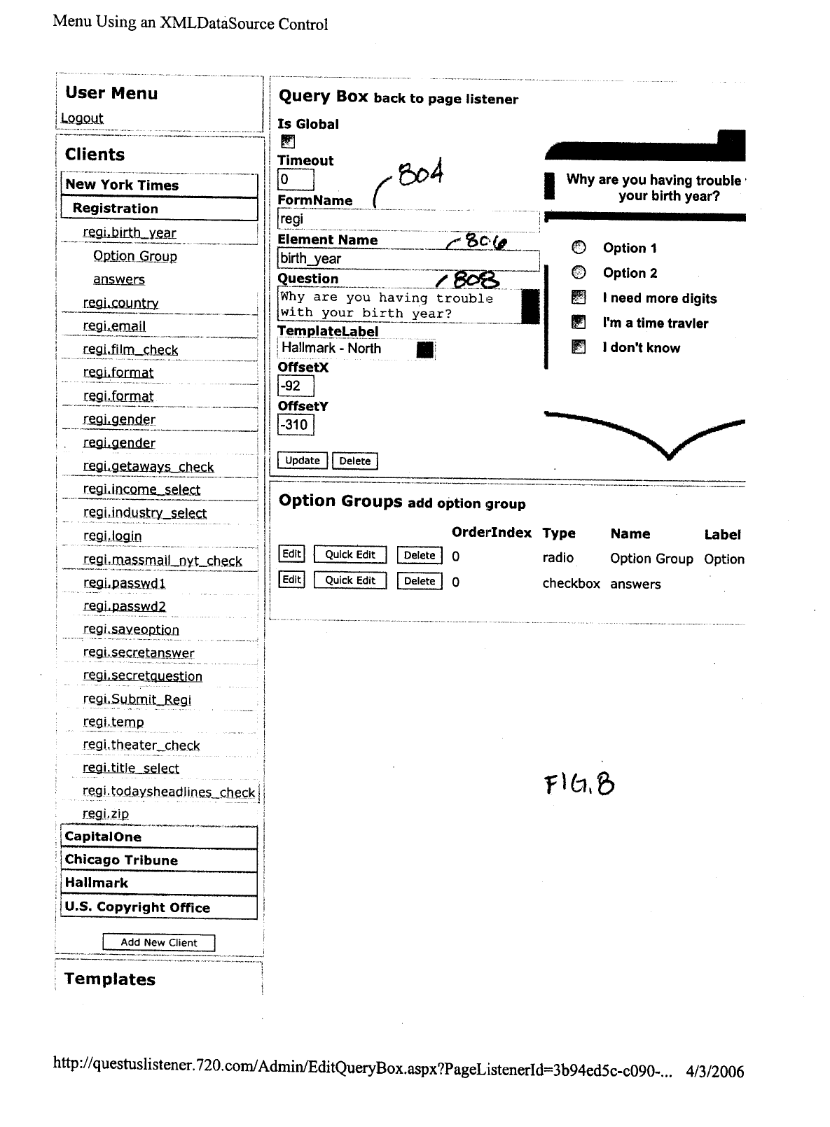

FIG. 7 is a flow diagram illustrating one embodiment of a method of generating a web page listener object (e.g., a querybox) using an administrative tool such as that illustrated in FIG. 6. FIG. 8 is a screenshot of the administrative tool for generating a web page listener object, including form fields for user entry of listener object parameters. In FIG. 7, a user initially selects a web page form, such as “registration” (regi), in operation 705. The web page form may be selected from a drop down menu, for example, or may be input manually via a keyboard into the “FormName” field 804 as shown in FIG. 8. Following form selection in operation 705, the user selects the form element or field to which the listener object is to attach, such as “birth_year” or “login”, and inputs the selection into the “Element Name” field 806 in operation 710.

In operation 715, the user selects a listener object (e.g., querybox) trigger event and inputs relevant information. For example, the trigger event may include a timer in which case the user inputs the duration of the timer in operation 715. The trigger event may be an onload or global trigger, where the querybox is to be displayed to the web page viewer upon loading of the web page. Further, the trigger may be a combination of an onload trigger and a timer such that the querybox is displayed after the web page is loaded and the timer times out. As will be appreciated by those skilled in the art, other trigger events may be employed for the listener object.

Following selection of the listener object trigger event in operation 715, the user inputs text, such as a question, for the querybox in operation 720. For example, the user may input the question text “Why are you having trouble with your birth year?” at the “Question” field 808 as illustrated in FIG. 8. After entry of the question text for the querybox in operation 720, the user selects a querybox template in operation 725 from a plurality of stored templates. As discussed above, the template is the physical appearance of the querybox, such as the shape, color, and size. The template may or may not include text. For example, the querybox illustrated in FIG. 8 may be positioned directly above its associated form field or element on the web page (e.g., regi, birth_year). Alternately, the querybox template may comprise a shape corresponding to positioning to the left, right, or below its associated form field on the web page. In one embodiment, the template may include the text “Close” and its corresponding mouse input box. The template may also include the text “Submit” and a corresponding mouse input box for viewer submission of their input. In some embodiments, viewer input is automatically submitted upon selection of one of the user input options.

After selection of the querybox template in operation 725, the user selects one or more web page user inputs options and input text in operation 730, such as a check box with the text “I'm concerned about identity theft”. As illustrated in FIG. 8, a web page user input option may comprise, for example, a checkbox and text, such as “I need more digits”. Following selection of the web page user input options in operation 730, the user inputs the querybox x/y offset information in operation 735, thereby designating the position of the querybox in relation to the web page displayed to a viewer.

In one embodiment, the method of generating a web page listener object further comprises user input of the percentage of web page users to receive or view the listener object in operation 740. Finally, the listener administrator generates an array of template strings and a form string for each querybox, including the x/y offset information and objects for functionality of the listener according to the user inputs from operations 705 through 740, and stores the strings and objects at the listener database 745. The Template strings are created, encoded and compressed at the time a template is added to the system. This created, encoded and compressed template string is stored in the database so that the time intensive process of creating the template string does not need to be done on every request. This helps improve performance. Further, the same create-encode-compress-store system is used for the firm strings that are rendered as the body of a querybox. At least a portion of the content generated by the listener administrator in operation 745 is included in the information sent from the listener server 208 to the web page server 206 for modification of the web page to include the listener functionality.

Thus, the embodiments of the web site user feedback capture system provide for customized web site user input captured in real-time, and specific to particular web page content. In the examples described above, a user is prompted for input with regard to a specific form field of a web page when they fail to enter information after a specified period of time. Thus, the system obtains feedback on reasons the user failed to enter the information, and potentially reasons the user may not submit any information to the web page provider. Thereby, the provider can obtain feedback for use in improving their web page content and their business in general.

The foregoing description details certain embodiments of the invention. It will be appreciated, however, that no matter how detailed the foregoing description appears, the invention can be practiced in many ways. Also, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A method of capturing user input upon user viewing of a web page, comprising:
providing a web page with at least one trigger for displaying a request for user input;
providing a prompt requesting user input specific to an element of the web page in response to an automatic trigger event;
receiving user input in response to the request; and
storing the received user input.

2. The method of claim 1, wherein the trigger event comprises at least one of a focus event, a mouse event, a keyboard event, and a selection event.

3. The method of claim 1, wherein the trigger event comprises a timer.

4. The method of claim 1, wherein the at least one trigger is associated with a particular form field on the web page, and wherein the prompt requesting user input includes a text specific to the particular form field.

5. The method of claim 4, wherein the prompt requesting user input comprises at least one user input option specific to the particular form field.

6. The method of claim 1, wherein the user input is received from a client computer.

7. The method of claim 1, wherein a unique identifier is associated with the prompt, and wherein the unique identifier is received with the user input.

8. A system for capturing user input upon viewing a web page, comprising:
a listener server coupled to a communications network and configured to store content for modifying at least one web page with functionality that enables automatic capture of user input upon viewing of the web page, wherein the content comprises at least one trigger event and a corresponding prompt requesting user input customized to the trigger event.

9. The system of claim 8, wherein the listener server is further configured to receive and store user input in response to the prompt.

10. The system of claim 9, wherein the listener server is further configured to maintain substantially all user input in response to the prompt for substantially all web page viewers receiving the prompt.

11. The system of claim 8, wherein the prompt comprises a querybox posing a question to the user and one or more user input options.

12. The system of claim 8, wherein the content is stored at a listener server address which is embedded in the web page code.

13. The system of claim 8, wherein the content comprises at least one instruction to override at least one event for the web page.

14. The system of claim 13, wherein the at least one event is an onload event and wherein the onload event is overridden to include an initialization of the at least one prompt.

15. The system of claim 8, wherein the listener server is further configured to facilitate generation of listener objects for a web page, wherein a listener object comprises identification of a trigger event and customized content for a prompt requesting user input.

16. The system of claim 8, wherein the at least one trigger event comprises a form field onfocus event, and wherein the at least one prompt includes text associated with expected input to the form field.

17. A system for capturing user input upon web page viewing, comprising:
a web page server coupled to a communications network and configured to respond to a client computer request to load a web page, modify the web page to include functionality that enables automatic capture of user input upon viewing of the web page, and send the modified web page to the requesting user, wherein the modified web page comprises at least one trigger event and at least one corresponding prompt requesting user input customized to the trigger event.

18. The system of claim 17, wherein modifying the web page to include the functionality that enables automatic capture of user input comprises overriding web page events.

19. The system of claim 17, wherein the at least one trigger event comprises at least one of a focus event, a mouse event, a keyboard event, a selection event, and a load event.

20. The system of claim 17, wherein the at least one trigger event comprises a timer.

21. The system of claim 17, wherein the web page server is further configured to run a script in response to the client computer request to load the web page, wherein the script is embedded in the web page.

22. The system of claim 17, further comprising a listener server coupled to the communications network and configured to provide web page content to the web page server for use in modifying the web page to include the functionality that enables automatic capture of user input.

23. A method of capturing user input upon viewing of a web page, comprising:
receiving a user request to load a web page comprising user input capture functionality;
requesting user input capture functionality content from a listener server;
receiving content to enable user input capture functionality on the web page, wherein the received content comprises at least one trigger event and corresponding prompt requesting user input specific to an element of the web page;
modifying web page content to include at least a portion of the received content; and
sending the modified web page to the user.

24. The method of claim 23, wherein the user input capture functionality comprises a script call to the listener server.

25. The method of claim 23, wherein modifying the web page content comprises modifying the onload function for the web page to include an initialization of the at least one prompt requesting user input.

26. The method of claim 23, wherein modifying, the web page content comprises adding the at least one trigger event to the web page code.

27. The method of claim 23, wherein the at least one trigger event comprises at least one of a focus event, a mouse event, a keyboard event, and a selection event.

28. The method of claim 23, wherein the at least one trigger event comprises a form field onfocus event, and wherein the at least one prompt includes text associated with expected input to the form field.

29. A method of providing content for modifying a web page to include customized user input capture functionality, comprising:
receiving a request from a web page server for user input capture functionality content for a web page;
identifying and sending content to enable user input capture functionality for the web page to the web page server, wherein the content comprises at least one trigger event and at least one prompt requesting user input customized to the trigger event; and
receiving user input in response to the prompt.

30. The method of claim 29, further comprising determining whether to provide content to enable user input capture functionality based on a predefined fraction of users designated to receive the content.

31. The method of claim 29, wherein the at least one trigger event comprises a form field onfocus event, and wherein the at least one prompt includes text associated with expected input to the form field.

32. The method of claim 29, wherein the content to enable user input capture functionality comprises at least one template string, and at least one configuration object for configuring the at least one trigger event and the at least one prompt requesting user input.

33. The method of claim 29, wherein the content comprises at least one predefined generic template and at least one customized form for each trigger event.

34. The method of claim 29, wherein the at least one trigger event comprises at least one of a focus event, a mouse event, a keyboard event, a selection event, and a load event.

35. A method of capturing user input upon user viewing of a web page, comprising: requesting a web page comprising automatic user input capture functionality;
loading and displaying a web page enabled with automatic user input capture functionality content, wherein the content comprises at least one automatic trigger event and a corresponding prompt requesting user input specific to an element of the web page;
detecting the at least one trigger event and displaying the corresponding prompt requesting user input specific to an element of the displayed web page;
receiving user input in response to the displayed prompt; and
sending the user input to a listener server.

36. The method of claim 35, wherein the prompt requesting user input comprises text associated with the trigger event and one or more user input options.

37. The method of claim 35, wherein the trigger event comprises a focus event for a form field, and wherein the prompt requesting user input comprises a question associated with the expected input to the form field.

38. The method of claim 35, wherein the at least one trigger event comprises at least one of a focus event, a mouse event, a keyboard event, and a selection event.

39. The method of claim 35, wherein the at least one trigger event comprises a timer.
